(19) United States
(12) Patent Application Publication
(10) Pub. No.: US 2018/0253803 A1
(43) Pub. Date: Sep. 6, 2018

(54) SYSTEMS AND PROCESSES FOR INDEPENDENT RECONCILING OF CRUDE OIL PURCHASE TRANSACTIONS

(71) Applicant: EMK3 Energy Matrix, LLC, Fairview, TX (US)

(72) Inventors: William L. Wittsche, Allen, TX (US); Kenneth Cavner, Guthrie, OK (US)

(21) Appl. No.: 15/448,224

(22) Filed: Mar. 2, 2017

(51) Int. Cl. G06Q 50/06; G06Q 40/00

(52) U.S. Cl. CPC G06Q 50/06; G06F 3/0484; G06Q 40/12

(57) ABSTRACT

Disclosed are systems and processes for providing independent reconciliation of net volumes for crude oil purchases. In one embodiment, a system comprises one or more producer client applications for use by a producer of crude oil for collecting and uploading data points related to a purchase for a net volume of crude oil, and one or more purchaser client applications for use by a purchaser of crude oil for collecting and uploading data points related to the purchase for the net volume of crude oil. A system may also comprise one or more servers configured to receive the data points from the client applications, as well as one or more databases configured for storing the data points. A system may also comprise one or more processors configured to reconcile the data points from the producer client applications with corresponding data points from the purchaser client applications to determine the net volume of crude oil for the purchase. A system may then present the determined net volume of crude oil for the purchase to the producer via one or more of the producer client applications and to the purchaser via one or more of the purchaser client applications.

### TECHNICAL HELD

The present disclosure relates to crude oil purchase transactions, and in particular to systems and processes for a new approach to data gathering and reconciliation of crude oil purchase transactions.

### BACKGROUND

Crude oil has been produced in the U.S. for almost 150 years. Crude oil comes out of the ground and is stored in a tank or multiple tanks (sometimes referred to as a “tank battery”). Once crude oil is removed from the ground and placed in storage tank(s), it is eventually transferred in portions into oil trucks or, alternatively, the tank(s) may be connected to a pipeline so that the crude oil is removed from the tanks by being pumped into the pipeline. When crude oil comes out of the ground, it is called “production.” The production comes from an oil well, with the well typically located on an oil lease. The storage tanks discussed above are typically located near the wells from which the crude oil is produced, and thus the oil production can by quickly placed in the storage tanks as it is removed from the ground.

Crude oil may be sold Fee on Board (FOB) at the tanks or, as more commonly occurs, the crude oil may be trucked from the tanks and sold into other tanks, downstream from the well. The company who owns the crude oil that is produced from the ground is called in the industry the Producer. The company who first purchases the crude oil directly from the Producer is called the First Purchaser. And the company who transports the crude oil on behalf of the First Purchaser is typically a Trucking Company or a Pipeline. Moreover, in many cases the Trucking Company and the First Purchaser are actually the same company.

When a First Purchaser purchases a certain amount of production from a Producer, a final price must be determined. In the industry, the Net Volume of crude oil removed from a tank and received by a First Purchaser is what the final price is based upon. Thus, the Producer and the First Purchaser must agree on the Net Volume that is sold by the Producer and purchased by the First Purchaser. The oil and gas industry has determined that the official crude oil Net Volume on which the final price is based is the volume of crude oil at 60° Fahrenheit, less “Basic Sediment and Water” (called in shorthand “BS&W”) determined to be present in the purchased oil.

The volume of crude oil in a tank expands as the temperature rises and contracts when the temperature decreases. Also, the gravity of crude oil, or the weight of crude oil compared to the same volume of water, influences the Net Volume calculation. A gravity greater than 10 and the crude will float on water, a gravity less than 10 and the crude will sink in water. In addition, water and sediment is present within crude oil in microscopic quantities and free water can be contained within the crude oil as well, all of which comprises the BS&W. Each storage tank has a fill line to receive production from a well or multiple wells, as well as a suction line that is used by the trucks for pumping the crude oil out of the tank and into the oil trailer. This suction line is typically located at 6 inches above the bottom of each tank. Generally, the fluid below the suction line is not merchantable crude oil because it contains too much water and sediment.

In a simplified explanation of the conventional crude oil purchase process, the trucking company sends a truck with an oil trailer to a crude oil tank in order to remove the oil from the tank and transfer it into the truck's trailer. Before any oil is removed from a tank, conventional industry practice is for the Producer to gather data related to the oil in the tank needed for calculating the amount of production being removed by a given truck. Conventional industry practice also has the truck driver or other person affiliated with the truck to gather their own collection of data to make their determination of the amount of crude oil being pulled from a tank and placed into a truck. To determine the volume (and thus the price) to be paid for by the First Purchaser to the Producer for a given load of oil, the data gathered/calculated by the First Purchaser is sent to the Producer to be reconciled with the data gathered/calculated by the Producer for that given load of oil.

Unfortunately, several disadvantages exist with the conventional technique for determining the Net Volume of crude oil being purchased. For example, the Net Volume in the oil trailer can decline over the time it takes to travel to the delivery point due to evaporation. Also, there are often multiple drivers/trucks picking up crude oil from multiple tanks and Producers, and all of them delivering crude oil into the same delivery point tank; thus, it is often not possible to reconcile one delivery point tank to one production point tank. Another factor is that trucking companies/First Purchasers generally reconcile their run tickets (receipts at the Producer location(s)) to run tickets (at delivery point(s)) on a weekly or monthly basis, which can lead to inaccurate net calculations and reconciliation difficulty. There are also a number of factors associated with the Producer that can result in the calculated Net Receipt Volumes of the Producer being difficult to reconcile with the Net Delivery Volume. These factors include the fact that a typical storage tank will generally contain more than one truckload of crude oil, or there are multiple tanks and multiple trucks taking crude oil out of all of the tanks in one day, and sometimes taking measurements between truck loads from a single tank does not take place. Another factor can be differences in the measurement equipment or “strapping tables” used by the two parties, and thus the accuracy for volume comparison may be compromised. Also, each Producer may have hundreds of loads per day with multiple truckers/First Purchasers, and trucking companies may also have hundreds of loads per day with multiple Producers. Thus, the Producers are processing all of their run tickets to determining multiple Net Receipt Volumes in their proprietary system, and the First Purchasers are processing all of their run tickets using their proprietary system. Thus, the sheer volume of information in separate systems often results in inaccurate reconciliations among the multiple Producers and First Purchasers due to the multiple proprietary systems for calculating Net Volume not permitting the exchange of information accurately and efficiently for reconciling purposes.

There is a need, therefore, for a unique system and process that provides a new approach to data gathering and reconciliation of crude oil purchase transactions that does not suffer from these and other deficiencies found in the conventional industry practice for reconciling each parties' run tickets. The disclosed principles provide such a unique approach to crude oil purchase transactions.

### SUMMARY

To overcome the deficiencies of the prior art, the disclosed principles provide for various embodiments of unique systems and processes that provides a new approach to data gathering and reconciliation of crude oil purchase transactions. In one aspect, systems for providing independent reconciliation of net volumes for crude oil purchases are disclosed. In one embodiment, a system may comprise one or more producer client applications for use by a producer of crude oil for collecting and uploading data points related to a purchase for a net volume of crude oil, as well as one or more purchaser client applications for use by a purchaser of crude oil for collecting and uploading data points related to the purchase for the net volume of crude oil. In addition, such an embodiment may also comprise one or more computing servers, embodied in both hardware and software executed thereon, connected to a computer network, such as the Internet, wherein the computing servers are configured to receive the data points from the one or more producer client applications and to receive the data points from the one or more purchaser client applications. Such systems may also include one or more databases, embodied in both hardware and software executed thereon, associated with the one or more computing servers and configured for storing the data points from the one or more producer client applications and from the one or more purchaser client applications. The system would also include one or more processors, embodied in both hardware and software, associated with the computing servers and the databases, and configured to execute code to reconcile the data points from the one or more producer client applications with the data points from the one or more purchaser client applications to determine the net volume of crude oil for the purchase. Moreover, the one or more computing servers may also be configured to present the determined net volume of crude oil for the purchase through the computer network and to the producer via one or more of the producer client applications and to the purchaser via one or more of the purchaser client applications.

In another aspect, methods for providing independent reconciliation of net volumes for crude oil purchases are disclosed. In one embodiment, a method may comprise executing one or more producer client applications by hardware of a producer of crude oil for collecting and uploading data points related to a purchase for a net volume of crude oil, as well as executing one or more purchaser client applications by hardware of a purchaser of crude oil for collecting and uploading data points related to the purchase for the net volume of crude oil. Such exemplary methods may also comprise receiving the data points from the one or more producer client applications and the data points from the one or more purchaser client applications across a computer network using one or more computing servers, embodied in both hardware and software executed thereon. The methods also comprise storing the data points from the one or more producer client applications and from the one or more purchaser client applications on one or more databases, embodied in both hardware and software executed thereon, associated with the one or more computing servers. Such methods may also comprise executing code on one or more processors, embodied in both hardware and software, associated with the computing servers and the databases to reconcile the data points from the one or more producer client applications with the data points from the one or more purchaser client applications to determine the net volume of crude oil for the purchase. Moreover, exemplary methods also comprise presenting, by the one or more computing servers, the determined net volume of crude oil for the purchase through the computer network and to the producer via one or more of the producer client applications and to the purchaser via one or more of the purchaser client applications.

Numerous embodiments and advantages associated with each such embodiments are discussed in further detail below.

### BRIEF DESCRIPTION OF THE DRAWINGS

The detailed description that follows, by way of non-limiting examples of embodiments, makes reference to the noted drawings in which reference numerals represent the same parts throughout the several views of the drawings, and in which:

FIG. 1 illustrates a flow diagram setting forth the currently employed conventional process for the reconciliation of a purchase of crude oil from a Producer by a First Purchaser;

FIG. 2 illustrates a flow diagram setting forth an exemplary embodiment of a reconciliation process in accordance with the disclosed principles;

FIG. 3 illustrates an exemplary screen shot from an application in accordance with the disclosed principles and configured for use by a Gauger;

FIG. 4 illustrates an exemplary application screen shot of the disclosed principles where a Gauger may enter collected data;

FIG. 5 illustrates an exemplary screen shot of data captured via an application of the disclosed principles and uploaded into a data table displayed on a screen;

FIG. 6 illustrates an exemplary screen shot of a Gauger Run Ticket generated by the independent system of the disclosed principles based on the uploaded data gathered via its client application;

FIG. 7 illustrates an exemplary screen shot from an application in accordance with the disclosed principles and configured for use by a truck driver or other associate of a First Purchaser;

FIG. 8 illustrates an exemplary application screen shot where a driver or other associate of the First Purchaser may enter collected data for a load of crude oil;

FIG. 9 illustrates an exemplary screen shot of a First Purchaser Run Ticket generated by the independent system of the disclosed principles based on the uploaded data gathered via the driver's client application;

FIG. 10 illustrates a screen shot of an exemplary Ticket Reconciliation operation provided by the independent system of the disclosed principles;

FIG. 11 illustrates a screen shot of an exemplary set of reconciliation results from a set of reconciliation parameters entered into the independent system of the disclosed principles;

FIG. 12 illustrates a screen shot of exemplary details of a specific run ticket reconciliation provided by the independent system of the disclosed principles;

FIG. 13 illustrates a screen shot of exemplary reconciliation results of run ticket pairs;

FIG. 14 illustrates a high level diagram of an exemplary embodiment of a system implemented in accordance with the disclosed principles.

### DETAILED DESCRIPTION

In view of the foregoing, through one or more various aspects, embodiments and/or specific features or sub-components, the present disclosure is thus intended to bring out one or more of the advantages that will be evident from the description. The present disclosure makes reference to one or more specific embodiments by way of illustration and example. It is understood, therefore, that the terminology, examples, drawings and embodiments are illustrative and are not intended to limit the scope of the disclosure.

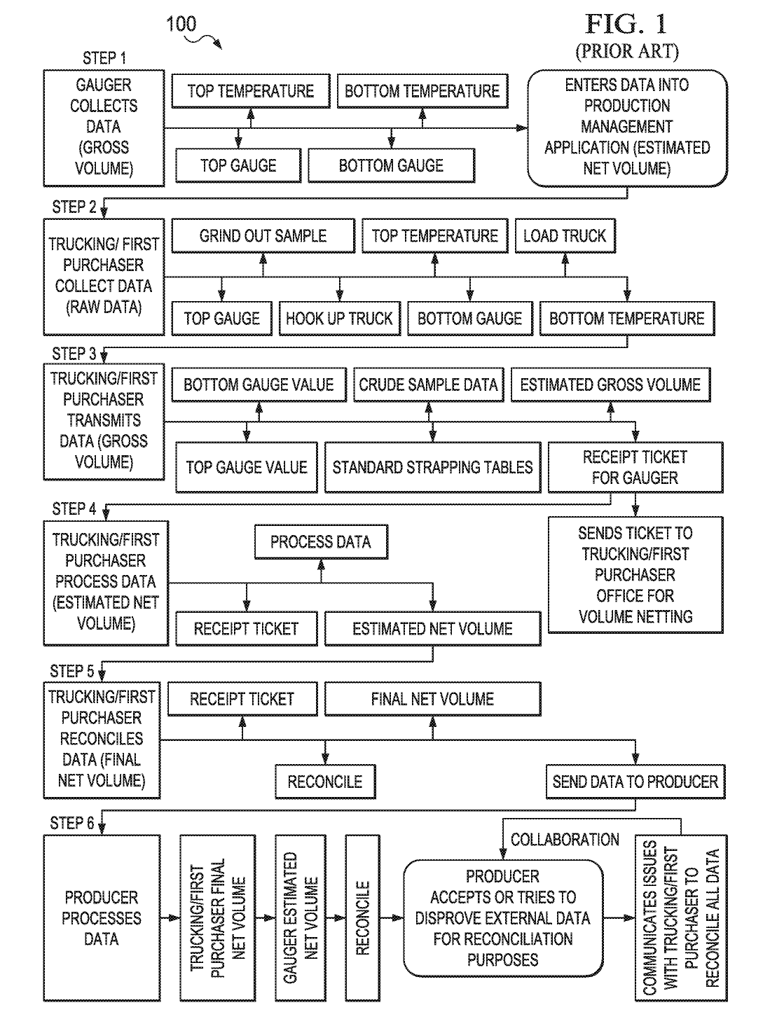

FIG. 1 illustrates a flow diagram 100 setting forth the currently employed conventional process for the reconciliation of a purchase of crude oil from a Producer by a First Purchaser. In the industry's conventional reconciliation approach, the Step 1 is for the Producer of the crude oil being sold to gather data in order to calculate the Gross Volume of crude oil being removed from a tank by a First Purchaser. For each such removal of production from a tank, the Producer employs a “Gauger” to gather the data needed for calculating the Gross Volume of production being removed by a truck.

As shown in FIG. 1, the Gauger's collection of data involves several distinct steps. First, the Gauger, from the top of the tank, drops a thermometer into the crude oil and takes a top temperature, middle temperature and bottom temperature, and records this information so an average “top temperature” of the crude oil in that tank before any removal can be calculated. Next, the Gauger drops a gauge line having a weight on its end to the bottom of the tank, and then holds the gauge line so that it is hanging perfectly straight. The Gauger must be careful that the weight at the bottom of gauge line is not leaning to one side. The Gauger records the exact reading where the top surface of the crude oil touches the gauge line at its highest point. Typically, this measurement is within one-sixteenth of an inch and is called the “top gauge.” After the truck removing the oil from the tank is connected and removes a certain amount, the Gauger repeats these two processes to determine both a bottom temperature and a bottom gauge, where the term “bottom” refers to measurements made with the amount of crude oil remaining in the tank, and not a temperature or a gauge reading from the bottom of the tank.

When the Gauger has recorded each of these measurements/calculations, the Gauger provides this data to the Producer, typically through what is called a “run ticket” for that particular removal transaction by that particular truck. The data in the run ticket is provided via the Producer's management software application, but may be provided in manual records as well. The Producer then uses the collection of data in the run ticket to calculate the estimated Net Volume of crude oil removed by the truck in this particular transaction. In should be noted that during a busy schedule, it may not be possible for the Gauger to take a bottom gauge between every load of crude oil that is removed from a particular tank through multiple trucks. In these situations, the Gauger may simply rely on the trucking company's bottom gauge measurements or other information (discussed below).

Step 2 of the conventional reconciliation process is when a person affiliated with the truck removing the crude oil collects their raw data, which is used by the First Purchaser to make their determination of the Gross Volume of crude oil being removed from a tank during a single transaction. Like the Gauger, the truck driver (or other person affiliated with the trucking company/First Purchaser) also drops a thermometer into the crude oil before any amount is removed and takes a top temperature, middle temperature and bottom temperature, and then records this information so an average “top temperature” before any removal can be calculated. Next, the driver also drops a gauge line having a weight on its end to the bottom of the tank, and like the Gauger he records the exact reading where the top surface of the crude oil touches the gauge line at its highest point to determine the “top gauge” measurement.

However, in addition to determining the top gauge and top temperatures before any crude oil is removed, the driver also will determine if the oil to be removed is of sufficient quality. For example, the driver may rub “water sampling paste” on the gauge line at the point where the bottom suction line is located in the tank, which as discussed above is usually about 6 inches from the bottom of the tank. The driver then removes the gauge line from the tank and looks to see if the water sampling paste has turned red (or other indicator) near the suction line, thus indicating too much water is in the crude oil at the suction level.

Alternatively, the driver can drop a crude oil sampling device (sometimes called a “thief”) to the suction level of the tank, and then capture a “grind out sample” of the crude oil at that level. The Driver may even decide to take multiple samples from the tank at different levels. Using a centrifuge or “sling out” machine, the driver sling's out the sample or the combined samples and determines if there is too much free water n the crude oil or too much BS&W in the tank. If there is too much water or sediment in the crude oil, the driver will reject the load. In addition, from these sample(s), the driver will also drop the hydrometer into sample and determines the gravity of the crude oil in the tank.

Assuming the crude oil is of sufficient quality, the truck is connected to the tank via a flexible hose used to pump oil from the tank into the oil trailer of the truck. The driver will pump the crude oil out of the tank and into his oil trailer until the level in the tank reaches the point at which the water is too great (suction line level) or until the trailer is full. Once pumping is completed, the driver drops the gauge line into the tank, as before, and records the “bottom gauge” as well as determines the “bottom temperature.” Once the process is complete, the driver records all of the information that was gathered above for use by the First Purchaser to determine the Net Volume taken from the tank. As discussed above, the Gauger may go to the tank after the truck leaves in order to determine a bottom gauge and bottom temperature, or alternatively the Producer may simply reply on these bottom data figures gathered by the driver.

Step 3 in the conventional reconciliation process, the Gross Volume of crude oil that was removed from the tank is calculated using a “strapping table” (for the size of tank that is being unloaded, based on volume in barrels). Specifically, the top gauge is entered into the strapping table and the Gross Beginning Volume is determined. Then, the bottom gauge is entered into the strapping table and the Gross Ending Volume is determined. The difference between the Gross Beginning Volume and the Gross Ending Volume is the Gross Volume of crude oil (before BS&W is subtracted) that was removed from the tank. Using the sample(s) of crude oil that was taken from the tank and spun out in a centrifuge, the percentage of BS&W was determined. From the Gross Volume before BS&W, the BS&W percentage is subtracted and this is the Gross Volume of crude oil removed from the tank as determined by the First Purchaser, which is also called the Gross Receipt Volume. A multiple part Run Ticket is prepared showing all of the information that is used for calculating the Gross Receipt Volume. One copy is left at the tank for the Producer and the remaining copies go to the First Purchaser.

Step 4 of the conventional reconciliation process is to calculate the Net Volumes using the data gathered from both parties. The Net Volume of crude oil that is removed from a tank is calculated using the following conventional process. Using a mathematical formula, the Gross Beginning Volume is adjusted for average gravity and average temperature, and this becomes the Net Beginning Volume. Using the same mathematical formula, the Gross Ending Volume is adjusted for average gravity and average temperature, and this becomes the Net Ending Volume. The difference between the Net Beginning Volume and the Net Ending Volume is the Net Volume of crude oil, before BS&W is taken into account, removed from the tank. Then, from the Net Volume before BS&W, the BS&W percentage is subtracted and this is the estimated Net Volume of crude oil removed from the tank. Using this Net Volume calculation process, the Net Volume for the Producer is determined from the information gathered by the Gauger and submitted to the Producer on a Gauger Run Ticket. Likewise, the Net Volume for the Trucking Company/First Purchaser is determined from the information gathered by the Truck Driver and submitted to the Trucking Company/First Purchaser on a Purchaser Run Ticket.

Step 5 of the conventional reconciliation process is the First Purchaser's internal reconciliation of their internal collected data. Thus, the First Purchaser determines their Estimated Net Receipt Volume of the crude oil that they have removed from a Producer's tank using the driver's information. The trucking company/First Purchaser run ticket (Receipt) showing Gross Volume is sent to trucking company/First Purchaser's office. Most trucking company/First Purchasers use their own proprietary software and strapping tables to calculate their Estimated Net Receipt Volume. It is noted that the trucking company/First Purchaser office often combines many Estimated Net Receipt Volumes that are all for crude oil going to the same delivery point. Also, the trucking company/First Purchaser office will often calculate the Estimated Net Delivery Volume for each delivery point that receives crude oil. The trucking company/First Purchaser office reconciles Estimated Net Receipt Volume to Estimated Net Delivery Volume for each delivery point, by day or week or month, depending on the quality of the data.

The reconciliation is needed between the Producer and the First Purchaser because the Net Volumes calculated by each party is considered to be only a preliminary estimate. This is the case because of several factors, such as that the top gauge readings can be in error, any of the temperature readings/averaging can be in error, the BS&W percentage can be in error because the sample from the tank was not an accurate indicator for the tank or was simply taken in error, the bottom gauge reading can be in error, the amount of free water calculated can be in error, or the Gross Volume calculated can be in error given standard strapping table errors.

Due to the probability of an error occurring in the calculation of Net Volume, it has been industry practice for many decades to have another calculation of Net Volume by the First Purchaser for comparison before the Official Net Volume is determined and provided to the Producer. This second calculation of Net Volume is typically called the Estimated Net Delivery Volume. If the reconciliation is within a specified tolerance, all of the Estimated Net Volumes are accepted and transmitted to the Producer as the Official Net Volumes as determined by the trucking company/First Purchaser. If the reconciliation result(s) is out of tolerance, then an incorrect Estimated Net Volume has been calculated on one or more First Purchaser's run tickets, and this mistake is found and the Estimated Net Volume is corrected. This corrected amount then becomes the Official Net Volume of the trucking company/First Purchaser. Also, it is not uncommon for this reconciliation by the trucking company/First Purchaser to be completed after the end of an accounting month, and the correction to be issued to the Producer as a Prior Period Adjustment (PPA).

In Step 6 of the conventional reconciliation process, the Producer reconciles its Gaugers' run tickets with the trucking company/First Purchaser's run tickets. Specifically, the Producer receives the trucking company/First Purchaser run ticket(s). The Producer then compares its Gauger run ticket (calculated Net) to the trucking company/First Purchaser run ticket (calculated Net) and calculates the difference between the two calculated amounts. If any difference is within a specified tolerance, then the trucking company/First Purchaser Official Net Volume is accepted. If any difference between run tickets is unacceptable, then the Producer contacts the trucking company/First Purchaser and compares the details of its Gauger run ticket(s) to the details of the driver(s) run ticket(s) in order to determine the correct volume. However, a crucial fact of the conventional reconciliation process is that if errors that cause differences between the Producer's information and the First Purchaser's information are not determined or the First Purchaser does not agree with Producer's asserted errors, the industry practice is that the Official Net Volume of the First Purchaser is what is typically accepted. Consequently, this provides an unequal distribution of power in favor of the First Purchaser since there is not a neutral third party in the industry to provide a final Official Net Volume that is accepted by both the Producer and the First Purchaser.

Throughout the standard industry reconciliation process, as discussed above, there are a number of factors associated with the trucking company/First Purchaser that can result in the calculated Net Volume at the delivery point of a truck (i.e., the Net Delivery Volume) being difficult to reconcile the First Purchaser's Net Volume with the Producer's calculated Net Volume (i.e., the Net Receipt Volume). These factors include the Net Volume in the oil trailer will decline over the time it takes to travel to the delivery point due to evaporation. Specifically,evaporation with respect crude oil in a trailer is proportional to the gravity of the crude oil, discussed above. Lighter crude oil, which has a higher gravity, will evaporate more quickly than heavier crude oil (lower gravity) because it has more water in it. Another factor is that if the delivery point is a large tank or contains a Lease Automated Custody Transfer (LACT) unit at the tank's input, which assist with the handling of incoming crude oil in an automated manner, it is typically not possible to calculate the Net Volume for every individual truck delivery. Also, there are often multiple drivers/trucks picking up crude oil from multiple tanks and Producers, and all of them delivering crude oil into the same delivery point tank; thus, it is often not possible to reconcile one delivery point tank to one production point tank. Yet another factor is that trucking companies/First Purchasers generally reconcile Purchaser run tickets (receipts at the Producer location(s)) to Purchaser run tickets (delivery points) on a weekly or monthly basis, which can lead to inaccurate net calculations and reconciliation difficulty.

There are also a number of factors associated with the Producer that can result in the calculated Net Receipt Volumes of the Producer being difficult to reconcile with the Net Delivery Volume. These factors include the fact that a typical storage tank will generally contain at least two truckloads of crude oil. A Gauger is typically in charge of a large geographic area such that it prevents the ability to measure a bottom gauge after the first load of crude oil is removed, and before the truck returns for the second load of crude oil; thus, the Purchaser's run tickets (Receipts) are simply combined in order to reconcile to the Gauger's run ticket. Also, many times there are multiple tanks in a tank battery and multiple trucks will arrive and take crude oil out of all of the tanks in one day. The Gauger can typically top gauge each tank and bottom gauge each tank, but often cannot take the bottom gauge between loads in each tank; thus, the Purchaser's run tickets are again combined in order to reconcile to the Gauger's run ticket. Another factor can be that the Producer has an exact strapping table for each of its tank; however, the truck drivers usually have a generic or standardized strapping table they use for all tanks of the same size; thus the accuracy for volume comparison may be compromised as volume per inch of tank can vary slightly. Yet another factor can be that the Gauger's run ticket must be transmitted to the Producer's field office or to the main office in order for the Gauger run tickets to have the Net Volumes calculated; thus, the timeliness for the Trucking Company is limited. Also, each Producer may have hundreds of loads per day with multiple truckers/First Purchasers. The trucking companies may also have hundreds of loads per day with multiple Producers. The Producers are processing all of their Gaugers' run tickets and determining Net Receipt Volumes using each Producer's proprietary system (whether manual or software based). Similarly, the trucking Companies/First Purchasers are processing all of their Purchaser run tickets in each's proprietary system. Thus, the sheer volume of information in separate systems often results in inaccurate reconciliations among the multiple Producers and First Purchasers due to the multiple proprietary systems for calculating Net Volume not permitting the exchange of information accurately and efficiently for reconciling purposes.

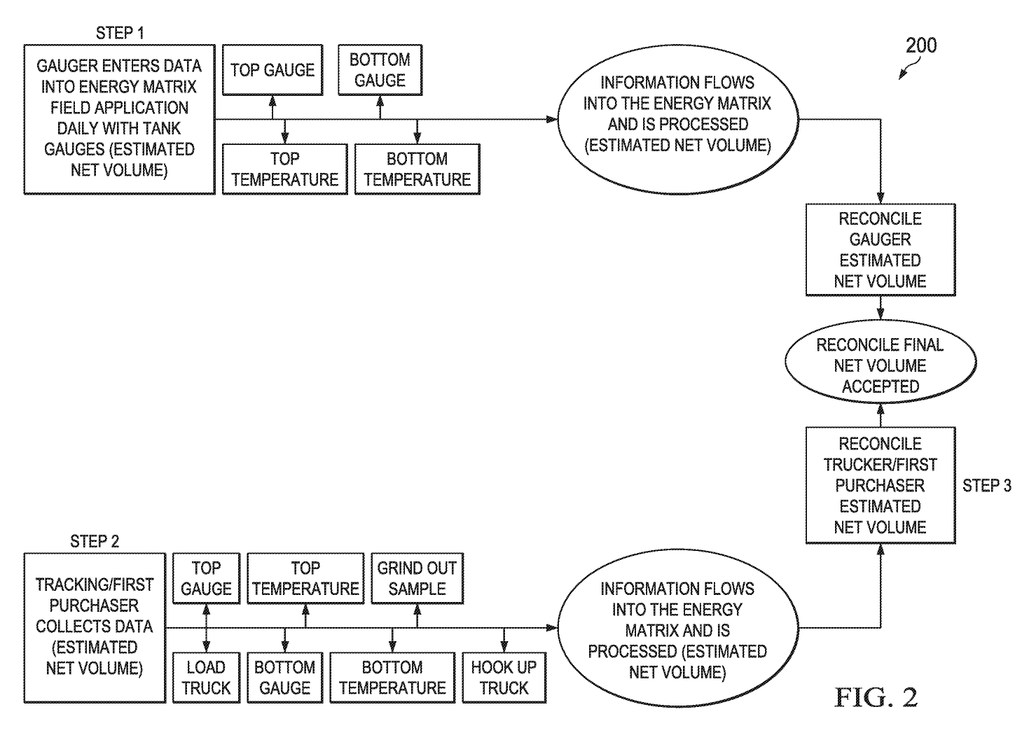

Turning now to FIG. 2, illustrated is a flow diagram 200 setting forth an exemplary embodiment of a reconciliation process in accordance with the disclosed principles, and which overcome the deficiencies of the conventional reconciliation process discussed above. Initially, as seen by the illustration, the disclosed principles provide for a far less complex reconciliation process, having far few steps and far less chances for errors in calculations. Also, although the illustrated embodiment is described in terms of crude oil purchases from a storage tank to an oil truck, the disclosed principles can apply equally to purchases made via pipelines or other manner of transporting oil from a Producer to a First Purchaser.

In Step 1 of a process in accordance with the disclosed principles, the Gauger associated with the Producer still makes the measurements as in the conventional process. As illustrated, this includes taking top and bottom gauge measurements, as well as taking the top and bottom temperature measurements, with the bottom measurements taken after a truck has pumped a load from the tank. However, a process according to the disclosed principles eliminates the need for the Producer or the First Purchaser to calculate their separate Net Volumes. Instead, under the disclosed technique, the Gauger enters that data in data fields of an application provided by a third party, such as the Assignee of the present disclosure. It should be noted that while the illustrated embodiment involves a Gauger gathering and inputting data, instead of data being gathered/calculated by a Gauger, the disclosed principles can provide for sensors to be installed in the storage tanks that can provide the various data points, as discussed in further detail below.

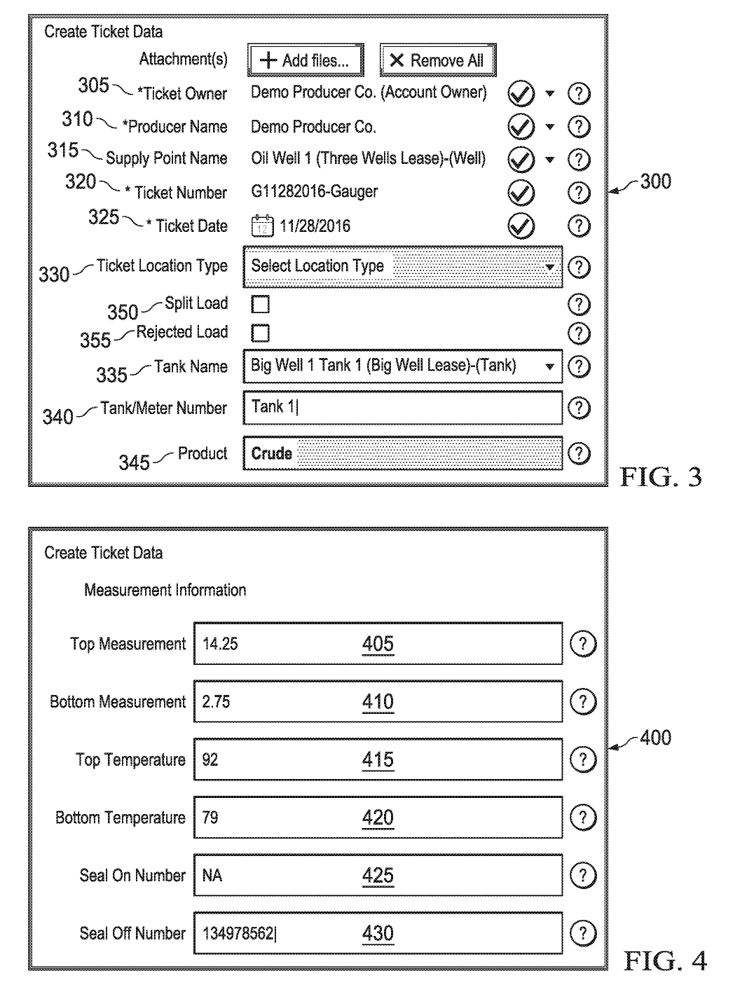

More specifically, looking briefly at FIG. 3, illustrated is an exemplary screen shot 300 from an application in accordance with the disclosed principles. Such an application may be configured to execute on a mobile device belonging to the Gauger, or it may be executed on a device provided by the Producer for the Gauger's use. This Gauger application screen 300 allows the Gauger to input general information about the transaction about to occur. This information includes items like the Account Owner's name 305 and the Producer's name 310 (which may be the same entity), the supply point 315 for the transaction, the run ticket number 320, the date 325, the location type 330 for the ticket being created, and the supply tank name 335 and number 340 being tapped. Also, the application may be employed in other industries for other products, although the illustrated screen shows that the subject transaction s for a product type 345 of crude oil. Fields to indicate whether the transaction is for a split load 350 or if a load has been rejected. 355 may also be entered in this exemplary Gauger application screen 300.

Now looking briefly at FIG. 4, illustrated is an exemplary application screen shot 400 where a Gauger may enter collected data. Data fields from such an application according to the disclosed principles can include data fields for Top Measurement 405 and Bottom Measurement 410 (i.e., Top and Bottom Gauge, as discussed above), as well as Top Temperature 415 and Bottom Temperature 420 of the tank indicated in the field of the Gauger application screen 300 shown in FIG. 3. Such an exemplary Gauger application screen 400 may also include data fields for Seal On Number 425 and Seal Off Number 430. The Seal On and Seal Off number refers to a physical tag made of a metal band with numbers stamped onto its surface. The seal must be removed before accessing the crude oil in a storage tank and a new one must be installed upon closing the tank. By noting the date and time seals are removed and installed on the tank, energy companies can track who has had access to the crude in the tanks.

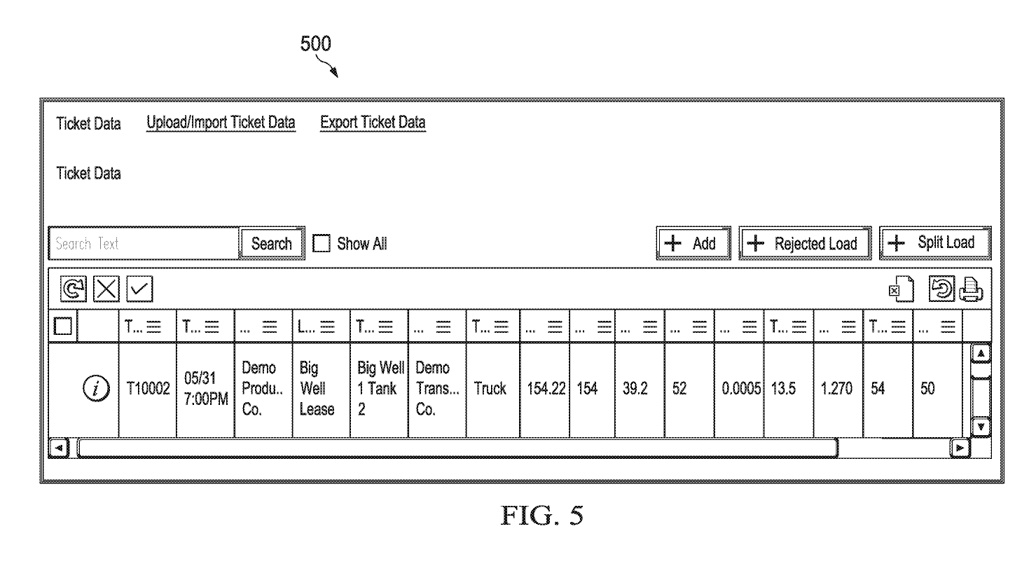

Once all of the information is entered into the disclosed system view the Gauger's application is executed in accordance with the disclosed principles, this information flows into the disclosed system, and the disclosed independent system processes the information to determine the Estimated Net Volume on the Producer's behalf. FIG. 5 illustrates an exemplary screen shot 500 of data captured via the application(s), and uploaded into a data table displayed on the screen 500. Such upload of run ticket data can occur in real-time if the application on the device employed by the Gauger is in communication with the disclosed system, or if the Gaugers' collected data can be stored on their devices by the applications until communication with the central system can be obtained. Such communication may be wireless, such as via a network or near-field communication (NFC) protocol, or a physical connection, such as a wired connection with the device executing the application or a transfer of the data from the device to the central system via storage media.

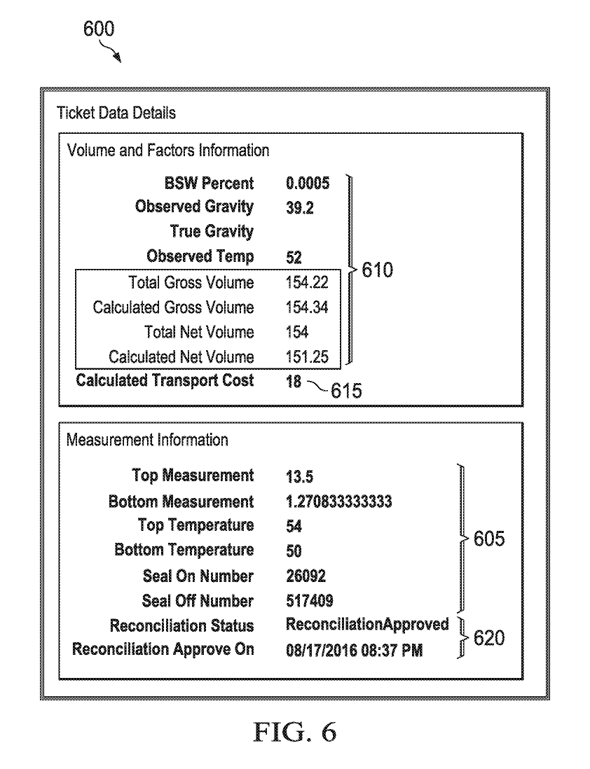

Once the data is uploaded into the central system of the disclosed principles, the system then calculates the Estimated Net Volume using the collected and uploaded data. Such calculation being provided by the disclosed third party system is done independently, but on behalf, of the Producer, and therefore alleviates the need for the Producer to maintain their own system. Accordingly, not only is the cost associated with purchasing and maintaining a data collection and calculation system by the Producer eliminated, but the time and other resources required to compile gathered information, especially those Producers who still manually employ “grease sheets” for data collection and manual entry of grease sheet data, is also saved. With hundreds of transactions per Producer occurring every year, the time and costs savings for each such Producer are significant. FIG. 6 illustrates an exemplary screen shot 600 of a Gauger Ticket generated by the independent system of the disclosed principles based on the uploaded data gathered via the mobile application. Such a generated Gauger Ticket may include not only the Gauger's data 605 gathered via the mobile application, but also the volume and other information 610 calculated using the uploaded data, which alleviates the Gauger from having to make those calculations. The generated Gauger ticket may also include the calculated transport costs 615, as well as reconciliation information 620, as illustrated in this exemplary screen shot 600.

Returning to FIG. 2, in Step 2 of a process in accordance with the disclosed principles, a truck driver or other person associated with the First Purchaser makes their measurements as in the conventional process. As illustrated, this includes taking top and bottom gauge measurements, as well as taking the top and bottom temperature measurements, with the bottom measurements taken after a truck has been hooked up to the tank and the crude oil loaded from the tank. In addition, the driver or other First Purchaser associate samples the crude oil as before to determine the BS&W using a grind out sample taken before loading.

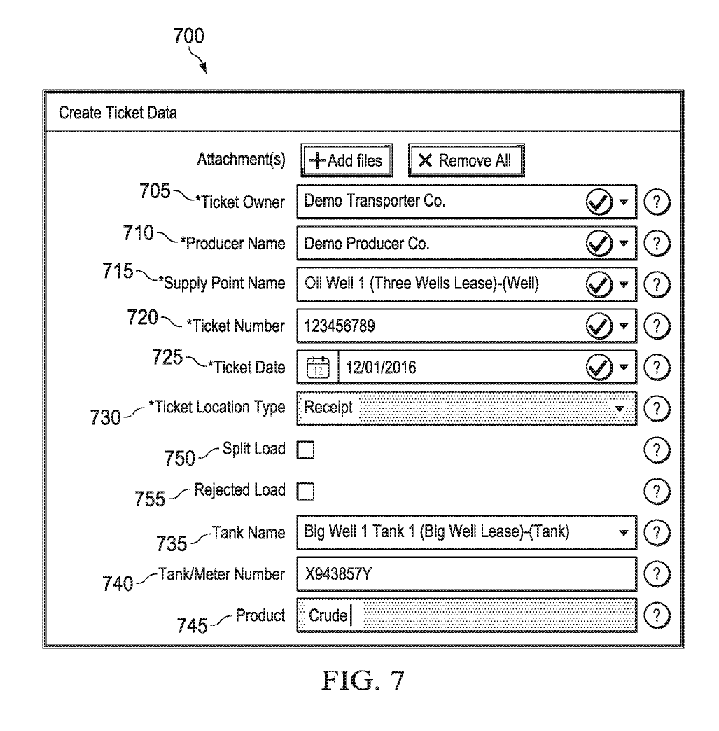

As with the Producer's side of the transaction, an independent system according to the disclosed principles also eliminates the need for the First Purchaser to calculate their separate Net Receipt Volume after loading the trailer. Instead, the disclosed process allows the driver or other First Purchaser affiliate loading the truck to enter their collected data in data fields of another mobile application provided by the disclosed independent system. The mobile application used by the driver/affiliate would provide a “Create Ticket” screen, such as the screen shot 700 shown in FIG. 7. As before, such an application may be configured to execute on a mobile device belonging to the driver, or it may be executed on a device provided by the First Purchaser for the driver's or other affiliate's use. This First Purchaser application screen 700 allows the driver to input general information about the load(s) they are about to take from a tank. This information includes items like the Account Owner's (i.e., First Purchaser's) name 705 and the Producer's name 710, the supply point 715 for the transaction, the run ticket number 720, the date of the ticket being created 725, the location type 730 for the ticket being created, and the supply tank name 735 and number 740 being tapped. Also, the application may be employed in other industries for other products, although the illustrated screen shows that the subject transaction is for a product type 745 of crude oil. Fields to indicate whether the transaction is for a split load 750 or if a load has been rejected 755 (e.g., based on BS&W findings) may also be entered in this exemplary First Purchaser application screen 700. As noted above, the disclosed principles can provide for sensors to be installed in the storage tanks and/or truck trailer that can provide the various data points on behalf of the First Purchaser as well.

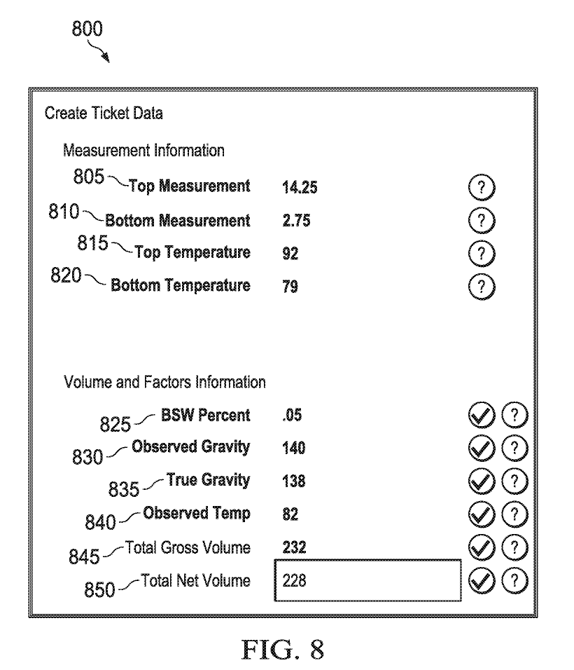

Turning briefly to FIG. 8, illustrated is an exemplary application screen shot 800 where a driver or other affiliate of the First Purchaser may enter collected data for a load they are picking up. Data fields from such an application according to the disclosed principles can include data fields for measurement information gathered by the driver, similar to those taken by the Gaugers, such as for Top Measurement 805 and Bottom Measurement 810 (i.e., Top and Bottom Gauge), as well as Top Temperature 815 and Bottom Temperature 820 of the tank indicated in the field of the First Purchaser application screen 800 shown in FIG. 8. Such an exemplary First Purchaser application screen 800 may also include data fields for volume information and factors calculated by the driver or other affiliate of the First Purchaser using a grind out sample spun by the driver when determining that the oil in the tank is of sufficient quality. Such volume and factor information may include the BS&W Percentage 825, the Observed Gravity 830, the True Gravity 835, and the Observed Temperature 840, and each of these may be entered into the driver's application screen 800. In addition, the Total Gross Volume 845 and. Total Net Volume 850 may also be calculated and entered into the First Purchaser application screen 800 by the driver or other affiliate.

Once all of the information is entered into the disclosed system view such a First Purchaser's application in accordance with the disclosed principles, this information flows into the disclosed system that is independent of both the Producer and First Purchaser. The input data from the driver's application could appear on a data screen similar to the captured data screen of FIG. 5. Then, also as before, the disclosed independent system processes the driver's input information to determine the Estimated Net Receipt Volume on the First Purchaser's behalf. Such upload of the driver's ticket data can occur in real-time if the application on the device employed by the driver or other affiliate is in communication with the disclosed system, or if the drivers' collected data can be stored on their devices by the applications until communication with the central system can be obtained, as discussed above.

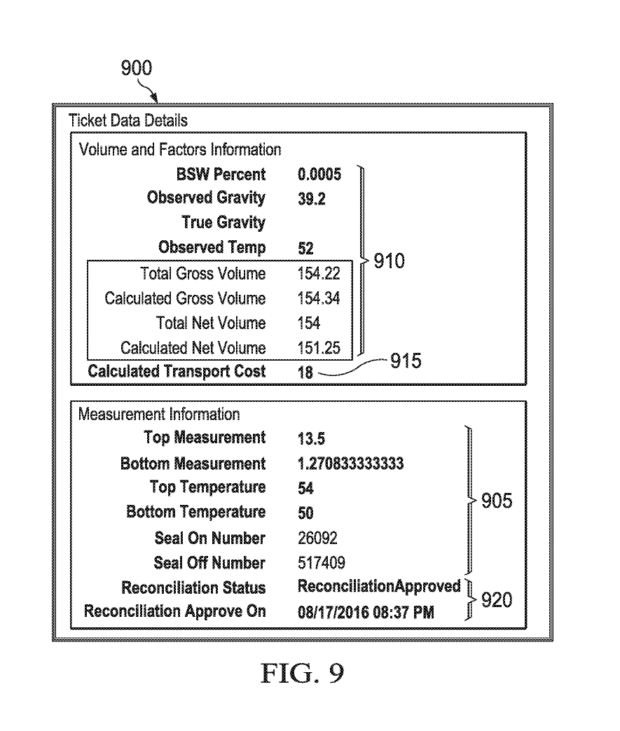

Once the data is uploaded into the independent central system of the disclosed principles, the system then calculates the Estimated Net Receipt Volume using the collected and uploaded data form the driver's application. Such calculation being provided by the disclosed third party system is done independently, but on behalf, of the First Purchaser, and therefore alleviates the need for the First Purchaser to maintain their own system. Accordingly, as it was for the Producer, not only is the cost associated with purchasing and maintaining a data collection and calculation system by the First Purchaser eliminated, but the time and other resources required to compile gathered information, especially those First Purchasers whose drivers/affiliates still manually employ “grease sheets” for data collection and manual entry of grease sheet data, is likewise saved. With hundreds of transactions per First Purchaser occurring every year, the time and costs savings provided by the independent system of the disclosed principles for each such First Purchaser are significant. FIG. 9 illustrates an exemplary screen shot 900 of a First Purchaser Ticket generated by the independent system of the disclosed principles based on the uploaded data gathered via the driver's mobile application. Such a generated First Purchaser Ticket may include not only the driver's data 905 gathered via the mobile application, but also the volume and other information 910 calculated using the uploaded data, which alleviates the driver or First Purchaser from having to make those calculations. The generated First Purchaser ticket may also include the calculated transport costs 915, as well as reconciliation information 920, as illustrated in this exemplary screen shot 900.

Returning again to FIG. 2, in Step 3 of a process in accordance with the disclosed principles, the Gauger Ticket information and the First Purchaser Ticket information are reconciled by the independent system. More specifically, before each side's tickets are reconciled, the system can provide a reconciliation of all of the Gauger's (i.e., Producer's) run tickets, as well as a reconciliation of all of the First Purchaser's run tickets. In this situation, all of the Producer's run ticket may be netted such that the net barrels are calculated on behalf of the Producer, and all of the First Purchaser's run ticket may be netted such that the net barrels are calculated on behalf of the First Purchaser. These initial separate nettings determine the Estimated Net Receipt and Delivery Volumes, respectively, for the Producer and First Purchaser.

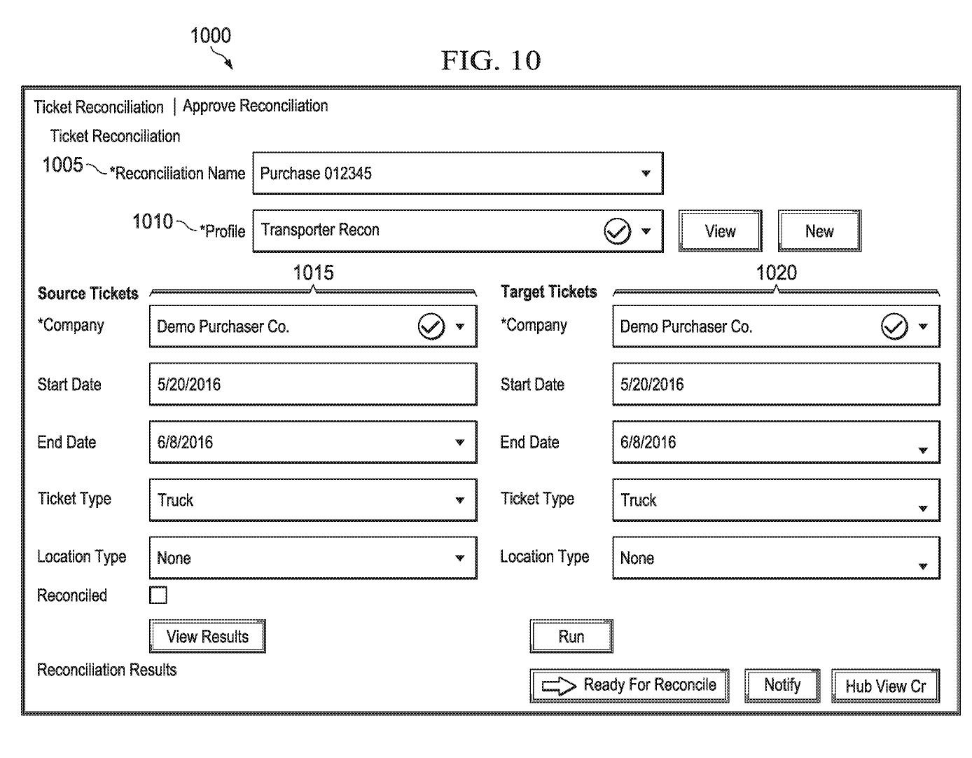

Looking at FIG. 10, illustrated is a screen shot 1000 of an exemplary Ticket Reconciliation operation provided by the independent system of the disclosed principles. The reconciliation screen provides a field 1005 for naming the reconciliation being done, as well as a field 1010 for the type of reconciliation being completed. In addition, the reconciliation screen provides for fields 1015 for the Producer and fields 1020 for the First Purchaser for narrowing down which tickets from each party are to be reconciled. These fields for narrowing which tickets are reconciled may include the names of the Producer and First Purchaser whose tickets are being reconciled, the start and end dates to define a specific data range for reconciliation, the type of run tickets being reconciled (e.g., truck tanker, pipeline, train tanker, etc.), as well as narrowing the reconciliation down to specific location if desired.

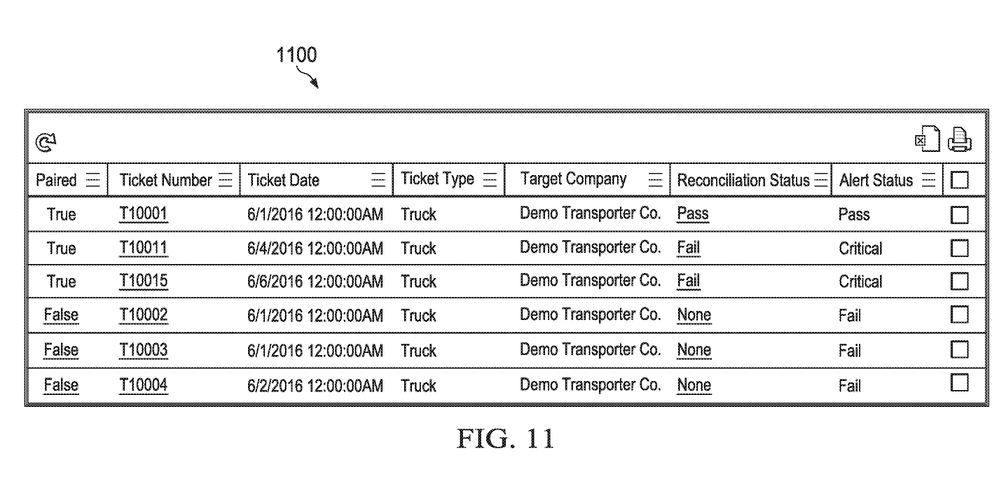

Once the user of the disclosed independent system provides the field information for the desired reconciliation, the system then reconciles the measurement and calculated data for each run ticket for both the Producer and the First Purchaser (e.g., the generated tickets shown in FIGS. 6 and 9) within the specified reconciliation parameters entered in the reconciliation screen of FIG. 10. FIG. 11 illustrates a screen shot 1100 of an exemplary set of reconciliation results from a set of reconciliation parameters entered into the disclosed system. As illustrated, the reconciliation results provided by the disclosed system may be presented in a ticket-by-ticket manner, where each run ticket reconciliation that is outside of the predetermined margin of error (as established by either or both parties, or perhaps as established by the system itself) can be presented as “Fail” or “Pass” indicating the status of each particular reconciliation. Also presented on the screen 1100 are links to other qualifying information about the reconciliation of each indicated ticket. The “Paired” column indicates if the system was able to establish/identify a pair of tickets for which to apply the reconciliation rules. The Ticket Number Field indicates the number of the ticket that is being reconciled. The “Alert Status” column indicates the type of event identified during the reconciliation rule execution in accordance with the disclosed principles. “Critical” indicates there is an error that is outside of the established tolerance that negates a particular reconciliation, while a “Warning” status indicates an error that is outside of tolerance but does not negate a particular reconciliation. An alert status of “Fail” indicates there was an error that disallows pairing or indicates missing data, while a status of “None” indicates the paired tickets reconciled with no error. Each indicator under each column may be a hyperlink which, when clicked, will display the nature of the error.

In some embodiments, the reconciliation results screen may only present those ticket reconciliations that are outside of the acceptable tolerances in order to simplify the results, or all ticket reconciliations may be presented and sorted by date, ticket number, results, or some other sorting parameter selected by the user. Also as illustrated, many of the fields presented in the reconciliation results screen may be links selectable by the user, which would then present specific information regarding the selected field value as it pertains to that run ticket reconciliation

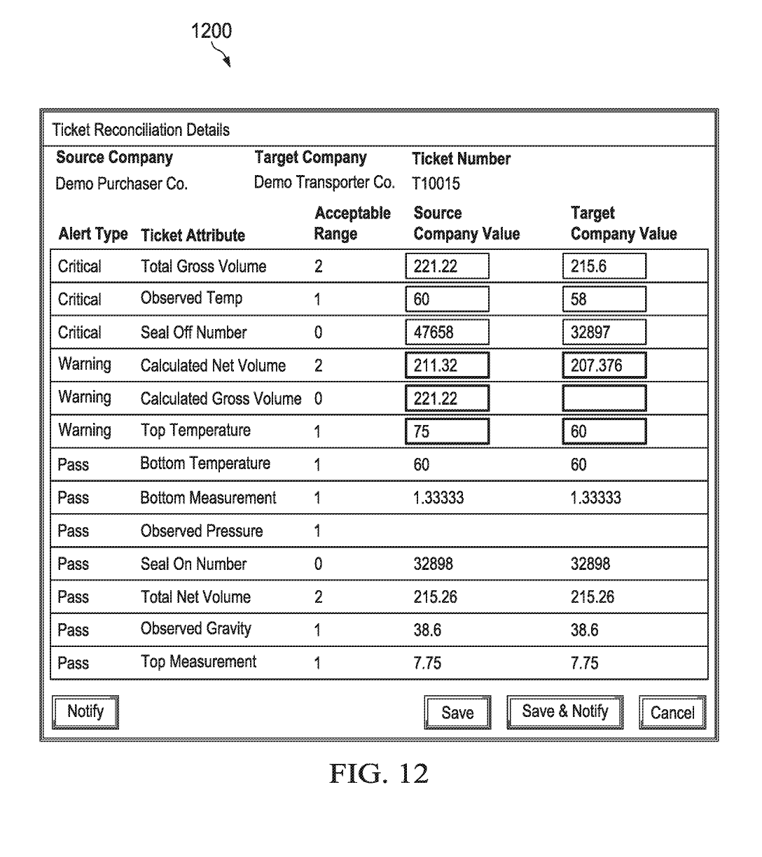

In addition, for each distinct run ticket reconciliation, a user of the system can then select (i.e., click) a particular reconciliation to view the details of that independent reconciliation. For example, FIG. 12 illustrates a screen shot 1200 of exemplary details of a specific run ticket reconciliation provided by the independent system of the disclosed principles. Specifically, the disclosed system provides a comparison of each data field/measurement entered by the personnel associated with the Producer and First Purchaser on their respective tickets via the applications provided by the disclosed system. Also, an acceptable tolerance or range is established for each of these data points, and thus the disclosed system identifies those data points that are within, outside of, or close to outside such preset acceptable tolerances. With such tolerances agreed to ahead of time by the parties, the reconciliation of each run ticket pair can be used to determine the percentage difference in net volumes as found from the data entered by each party's affiliate through the disclosed mobile applications. As illustrated, data that are within the acceptable tolerance may be indicated as “Pass,” data that are outside the acceptable tolerance may be indicated as “Critical,” and data that are nearing the acceptable tolerance may be indicated as “Warning.” Of course, other indicators may also be employed with the disclosed system.

By providing the distinct details of each run ticket reconciliation, the disclosed system allows either the Producer or the First Purchaser, or an independent agent using the disclosed system on behalf of both parties, to identify not only the run tickets that are outside (or almost outside) acceptable tolerance, but also the individual data items among the reconciled tickets. This level of detail then allows the Producer and First Purchaser to know what specific data items are at issue. Not only does this level of detail allow the parties to determine what happened with regard to that particular pair of run tickets, but also to work together to ensure that each party's representative (i.e., Gauger and truck driver) are properly taking and entering the required measurements. Providing this information to both parties from an independent source like a system according to the disclosed principles, allows the parties to determine how errors have occurred in a less contentious manner than if each party is simply relying on their own determinations.

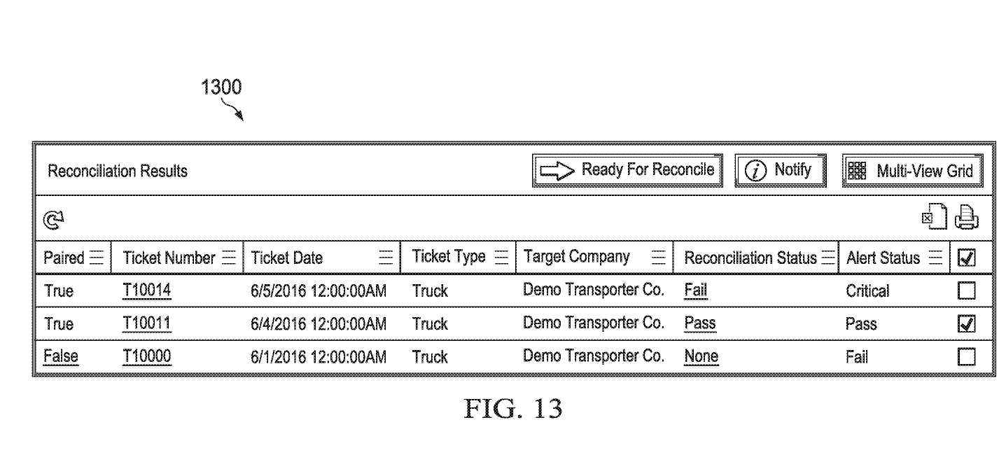

Turning now to FIG. 13, illustrated is a screen shot 1300 of exemplary reconciliation results of run ticket pairs, and provides the user o ability to indicate (e.g., via check mark) which reconciled run tickets are approved. As before, the disclosed system can be established so that either the Producer or First Purchaser can approve or reject reconciled tickets, or an independent third party can employ the disclosed system on behalf of the parties. Also as before, certain fields maybe made selectable so that the details of each particular ticket reconciliation can be viewed. Again, this allows the reconciliation process for all run tickets to take place in a less contentious manner since an independent third party, using the disclosed system, is agreed upon by the parties ahead of time.

It must be appreciated that this approach of employing an independent third party is new and completely contrary to the customary practice in the oil industry. Thus, the disclosed principles do not only provide a system that permits the automation of each party's data entry and needed calculations. The disclosed principles actually create a paradigm shift in the entire crude oil industry. Since the outset of modern crude oil industry practices, Producers have been at the mercy of the data measurements and calculations provided by the First Purchaser. As discussed in detail above, while the Producer's Gaugers take measurements and make calculations based on those measurements, the First Purchasers' associates do the same and provide their Estimated Net Delivery Volumes to the Producer for determining the price to be paid. If errors are determined by the Producer during a reconciliation, although those errors are brought to the attention of the First Purchaser, it is ultimately up to the First Purchaser to have the final say under current industry practices. However, with a system n accordance with the disclosed principles, this ultimate say is no longer in the hands of the First Purchaser and is instead agreed by both parties to be in the hands of an independent third party implementing the disclosed system and process. As mentioned above, this can eliminate potentially contentious situations between the parties when large discrepancies in data exists. Acceptable tolerance ranges can also be agreed upon ahead of time by the parties, and then implemented by the disclosed independent system. Also, with the collection of data from each party's run tickets, as well as the collection of data from each reconciliation of ticket pairs, trends in errors, if there are any, can also be tracked by the disclosed system and that independently determined information can be provided to the parties to assist them in finding and correcting possible errors either party may be committing throughout the purchasing process. In the conventional industry process where each party maintains their own data, such independent determination of possible error trends are not typically going to be possible.

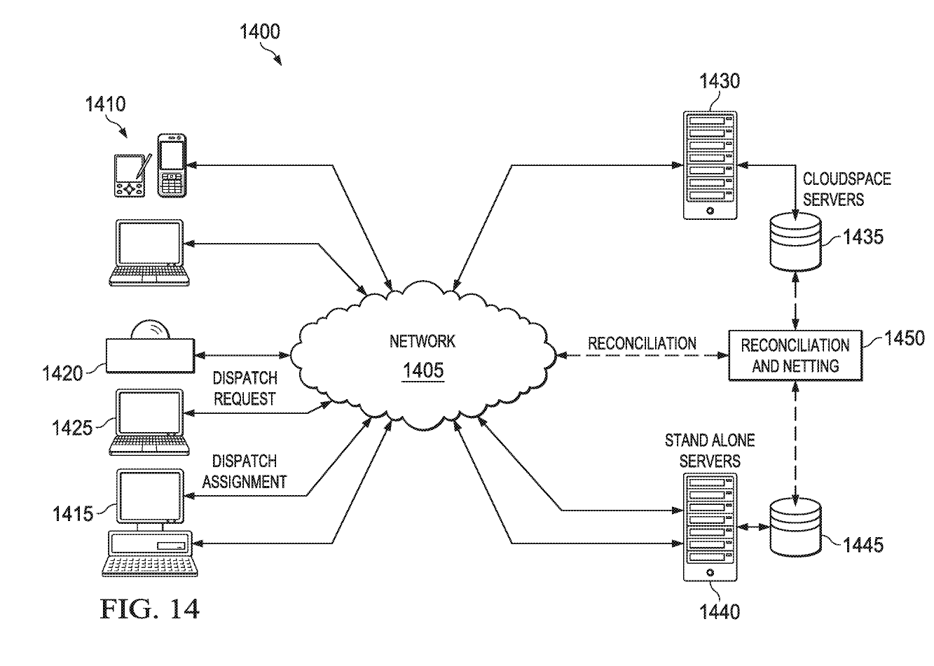

Looking now at FIG. 14, illustrated is a high-level diagram of an exemplary embodiment of a system 1400 implemented in accordance with the disclosed principles. The exemplary system 1400 illustrates how data (in the form of measurements, etc. as discussed above) can be input to the disclosed system 1400 and processed on behalf of multiple parties involved in crude oil or other similar product transactions. As illustrated, the disclosed system 1400 may be implemented via a computer network 1405, which could be an open network such as the Internet, or could be a private, proprietary network if desired.

The exemplary system 1400 may include direct input devices 1410 executing applications employed by associates of both Producers and First Purchasers. These could be the Gaugers and truck drivers conducting their duties in the manner discussed in detail above. When executing their duties, these associates could manually input their measurements and other data into a terminal or mobile device 1410 connected to the system 1400. Such devices 1410 can be stationary or mobile devices, and could be executing a client application configured to communicate with system-side processing machine(s), embodied in both hardware and software and configured to execute code to perform the functions discussed in detail above. This type of implementation of the disclosed principles would eliminate the need for manual “grease sheets,” which can be lost or damaged before the data is entered into either each party's own office equipment or uploaded into the disclosed system 1400.

Also, the disclosed system can include connection(s) from the Producer's and/or First Purchaser's individual data systems 1415. With this type of implementation, the employee(s)/associate(s) of the Producer/First Purchaser would gather their required data, and then provide that gathered data to each's Producer/First Purchaser system 1415. Those individual systems 1415 would then upload the input data to the disclosed system 1400 for processing and reconciliation, as discussed above. In such embodiments, the employee(s)/associate(s) of the Producer/First Purchaser could still be provided with an application of the disclosed system to assist them in gathering the required data, as could the machines in the Producer's and/or First Purchaser's offices (i.e., for office entry of the data from manual grease sheets), which would all allow for easy and even automatic upload (e.g., via NFC or other network connection) to the Producer/First Purchaser systems 1415. Such an approach would provide the additional benefit of not requiring Producers or First Purchasers to incur the expense and hassle of developing and maintaining their own internal data systems. Moreover, such an implementation would provide a uniform platform for all parties to gather and upload data. However, in other embodiments, the data could simply be emailed or otherwise sent to the disclosed system 1400, and then the system 1400 could have applications for extracting the data from such transmissions. In some embodiments, the parties (Producers and/or First Purchasers) could still employ their own proprietary software and internal system, for example, if they did not want to go through the hassle and expense of training their employees on a new platform such once in accordance with the disclosed principles. Instead, the disclosed principles could simply extract the data as mentioned above, or could provide for the creation of software modules to allow the proprietary client system and software to communicate with the disclosed system 1400, and thereby permit transfer of data to and from the client systems to the disclosed system 1400.

Still further, embodiments of the disclosed system 1400 can include software applications for execution on or with sensors 1420 installed on oil equipment, where those sensors 1420 gather some or all of the data needed for one or more transaction as described herein. For example, sensors 1420 can be installed oil storage tanks, and could gather data on any one or more of the top and bottom gauge (before and after each load is removed) and top and bottom temperatures (or other temperature measurements to assist in determining the average temperatures for each transaction). This information could be gathered by the sensors and automatically upload to the disclosed system's processors, or could be provided to the Producer's or First Purchaser's internal systems first, which in turn would provide the data to the disclosed system 1400. Sensors could also be positioned to measure and determine the gravity, free water and BS&W of oil loads automatically, which not only would provide consistency in data gathering, but also speed up the time required for each transaction. Any of such sensors could be provided by the disclosed system 1400, or could be provided by the Producer or First Purchaser, and then configured to communicate with the disclosed system 1400, if desired.

It should also be noted that any of the above device applications and sensors employed by the Producers and/or First Purchasers could also be implemented in pipeline transactions. In such embodiments, sensors 1420 or even manual entry of data in device applications 1410 would be used to gather the data related to crude oil being placed into the pipeline. The data gathered could again be sent directly to the disclosed system's processing machine(s), or could be first upload to a Producer's or First Purchaser's internal system, and then upload to the disclosed system 1400 for processing. As before, the use of a uniform platform for gathering and uploading such data would provide more efficiency in such pipeline transactions in the same manner as provided for truck load transactions.

Another feature provided by the disclosed system 1400 could be for dispatching crude oil pickups. For example, the system 1400 could provide a means to establish communications with automated systems, such as SCADA or other similar systems, to communicate the logistics and the specific producer of a particular volume of product that is ready for load out by a First Purchaser. Such dispatch information or alert could then be sent by the system 1400 to the First Purchaser/Trucking Company system 1415. Such dispatching could also be done using a manual method in the form of an alert or notification sent by either a Gauger or a Producer. The notification would alert the logistics company to dispatch a truck for the loadout to the identified site, again through the First Purchaser system 1415.

On the system-side of FIG. 14, the system 1400 can include multiple embodiments of equipment for implementing the disclosed principles. For example, the system 1400 can include cloudspace servers 1430, which are maintained in a distributed cloud-based platform. In addition, one or more databases 1435 could also be in communication with such cloud servers 1430, and such databases 1435 could also be maintained in a distributed computing environment. The system 1400 may also, or alternatively, be implemented with stand alone servers 1440, i.e., servers implemented and maintained in one or more locations affiliated with the third party implementing the disclosed system 1400. As before, one or more databases 1445 could also be in communication with such local servers 1440, and such databases 1445 could also be maintained locally by the third party.

In either deployed implementation, the parties to such oil transactions provide captured data to the data servers 1430/1440 of the system 1400 for processing as discussed above. As mentioned above, the data may be provided directly to the servers 1430/1440 via terminal/device 1410 applications or may be provided from the Producer's or First Purchaser's internal systems 1415. Not only could such data be provided automatically or via a file transfer from the Producer and/or First Purchaser, but either party's internal system 1415 could also be configured to connect with the disclosed system's servers 1430/1440 for direct, manual entry by personnel associated with the Producer or First Purchaser. In sum, the data gathered/measured/calculated by either party can be provided to the disclosed system's servers 1430/1440 in any manner, either now existing or later developed.

Once the required data for reconciling one or more run ticket transactions is provided to the disclosed system 1400, the system 1400 further includes processing equipment 1450, embodied in both processing hardware and software, to reconcile the uploaded data and provide the Net Volume for each transaction. More specifically, the processing machine(s) 1450 can be provided access to the uploaded run ticket data through one or more databases 1430/1440 storing such data. Once the required data is obtained, the processing machine(s) 1450 will conduct the reconciliation steps discussed in detail above on behalf of the Producer and First Purchaser. The overall reconciliation processing may be done by batch processing collections of data provided to the system 1400, or it may be done on an as-requested basis by the Producers/First Purchasers directly entering or uploading run ticket data, and then awaiting the reconciliation results in real-time. In either case, the system 1400 not only provides the reconciliation net volume results to the parties, but also can provide those results in manner that allows either party to access the details any particular reconciliation, such as the run ticket data provided by the other party or otherwise collected.

Consequently, as discussed above, a system 1400 constructed and implemented in accordance with the disclosed principles eliminates the First Purchaser (or any party for that matter) having the ultimate say in reconciled transactions when the results are outside an acceptable tolerance range. Instead, the crude oil industry is provided something it has not had before—an independent and unbiased third party to reconcile the ticket data on behalf of both parties. Moreover, the disclosed principles do not simply interject a third party into an otherwise two-party transaction, but instead does so by specifically providing not only the computing equipment to reconcile data and track data errors, but also by providing client based application, and even device if desired, to both parties to their use in gathering data during crude oil first purchase transactions. This not only saves the time and resources conventionally taken by the parties to reconcile the two groups of data, but also can eliminate potentially contentious situations between the parties when discrepancies in data exists. For example, the disclosed system 1400 can store run ticket data from as far back as desired, and then use that past data to help determine if a particular new data entry was significantly different that each time the same data point for past transactions was entered. This can quickly and easily identify an erroneous data entry or sensor reading, as well as use past similar data points to provide an estimate for what the erroneous data point should be. Alternatively, the erroneous data point can be shown to the parties, who could then simply agree to use the data point from the party providing valid data. Such tracking of individual data point errors or even error trends in cases where the same type of data is erroneous can be used to identify personnel or sensors that are not providing appropriate data points for transactions. Such personnel could then be properly trained or the person or sensors replaced so that correct data is provided for future transactions. Also, a system in accordance with the disclosed principles can combine First Purchaser run tickets in order to reconcile Gauger top and bottom gauges when the Gauger was not able to get bottom gauges between truck loads but the truck driver did make such measurements. Of course, other missing data point or similar information can also be provided by the disclosed system since the system comprises both parties' complete data sets.

In the numerous embodiments of the inventive subject matter disclosed herein, such embodiments may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus the following claims are hereby incorporated into the Detailed Description, with each claim standing on its own as a separate embodiment.

The Description has made reference to several exemplary embodiments. It is understood, however, that the words that have been used are for description and illustration, rather than words of limitation. Changes may be made within the purview of the appended claims, as presently stated and as amended, without departing from the scope and spirit of the disclosure in all its aspects. Although this description makes reference to particular means, materials and embodiments, the disclosure is not intended to be limited to the particulars disclosed; rather, the disclosure extends to all functionally equivalent technologies, structures, methods and uses such as are within the scope of the appended claims.

What is claimed is:

1. A system for providing independent reconciliation of net volumes for crude oil purchases, the system comprising:
one or more producer client applications for use by a producer of crude oil for collecting and uploading data points related to a purchase for a net volume of crude oil;
one or more purchaser client applications for use by a purchaser of crude oil for collecting and uploading data points related to the purchase for the net volume of crude oil;
one or more computing servers, embodied in both hardware and software executed thereon, connected to a computer network, and configured to receive the data points from the one or more producer client applications and to receive the data points from the one or more purchaser client applications;
one or more databases, embodied in both hardware and software executed thereon, associated with the one or more computing servers and configured for storing the data points from the one or more producer client applications and from the one or more purchaser client applications; and
one or more processors, embodied in both hardware and software, associated with the computing servers and the databases, and configured to execute code to reconcile the data points from the one or more producer client applications with the data points from the one or more purchaser client applications to determine the net volume of crude oil for the purchase;
wherein the one or more computing servers are further configured to present the determined net volume of crude oil for the purchase through the computer network and to the producer via one or more of the producer client applications and to the purchaser via one or more of the purchaser client applications.

2. A system according to claim 1, wherein reconciling comprises comparing data points from the one or more producer client applications with corresponding data points from the one or more purchaser client applications, and determining if any difference among corresponding data points is within a preset tolerance range.

3. A system according to claim 2, wherein the one or more computing servers are further configured to present the compared corresponding data points falling within the preset tolerance range to either or both of the producer and purchaser via respective produce or purchaser client application.

4. A system according to claim 2, wherein if any differences among corresponding data points are determined to fall outside of the preset tolerance range, the one or more computing servers are further configured to present the corresponding data points falling outside the preset tolerance range to either or both of the producer and purchaser via respective produce or purchaser client application.

5. A system according to claim 4, wherein the one or more computing servers are further configured to present the corresponding data points falling outside the preset tolerance range in response to an input from either or both of the producer and purchaser received via respective produce or purchaser client application.

6. A system according to claim 2, wherein the preset tolerance range for one or more of the data points is predetermined by agreement of the producer and purchaser.

7. A system according to claim 1, wherein the data comprises one or more of a top gauge measurement, a bottom gauge measurement, a top temperature reading, a bottom temperature reading, an average temperature determination, a gravity, a free water amount, or a base sediment and water determination of a storage of crude oil comprising the net volume of crude oil to be purchased.

8. A system according to claim 1, wherein at least one of the one or more producer client applications and/or at least one of the one or more purchaser client applications are embodied in one or more mechanical sensors associated with a tank having the crude oil to be purchased.

9. A system according to claim 1, further comprising one or more mechanical sensors associated with a tank having the crude oil to be purchased, wherein the one or more sensors are configured to communicate with one or more corresponding devices executing the one or more producer client applications and/or with one or more corresponding devices executing the one or more purchaser client applications, the sensors communicating one or more data points of the measurement data related to the purchase for the net volume of crude oil.

10. A system according to claim 1, wherein the computer network is the Internet.

11. A method for providing independent reconciliation of net volumes for crude oil purchases, the method comprising:
executing one or more producer client applications by hardware of a producer of crude oil for collecting and uploading data points related to a purchase for a net volume of crude oil;
executing one or more purchaser client applications by hardware of a purchaser of crude oil for collecting and uploading data points related to the purchase for the net volume of crude oil;
receiving the data points from the one or more producer client applications and the data points from the one or more purchaser client applications across a computer network using one or more computing servers, embodied in both hardware and software executed thereon;
storing the data points from the one or more producer client applications and from the one or more purchaser client applications on one or more databases, embodied in both hardware and software executed thereon, associated with the one or more computing servers; and
executing code on one or more processors, embodied in both hardware and software, associated with the computing servers and the databases to reconcile the data points from the one or more producer client applications with the data points from the one or more purchaser client applications to determine the net volume of crude oil for the purchase;
presenting, by the one or more computing servers, the determined net volume of crude oil for the purchase through the computer network and to the producer via one or more of the producer client applications and to the purchaser via one or more of the purchaser client applications.

12. A method according to claim 11, wherein reconciling comprises comparing data points from the one or more producer client applications with corresponding data points from the one or more purchaser client applications, and determining if any difference among corresponding data points is within a preset tolerance range.

13. A method according to claim 12, wherein the one or more computing servers are further configured to present the compared corresponding data points falling within the preset tolerance range to either or both of the producer and purchaser via respective produce or purchaser client application.

14. A method according to claim 12, wherein if any differences among corresponding data points are determined to fall outside of the preset tolerance range, the one or more computing servers are further configured to present the corresponding data points falling outside the preset tolerance range to either or both of the producer and purchaser via respective produce or purchaser client application.

15. A method according to claim 14, wherein the one or more computing servers are further configured to present the corresponding data points falling outside the preset tolerance range in response to an input from either or both of the producer and purchaser received via respective produce or purchaser client application.

16. A method according to claim 12, wherein the preset tolerance range for one or more of the data points is predetermined by agreement of the producer and purchaser.

17. A method according to claim 11, wherein the data comprises one or more of a top gauge measurement, a bottom gauge measurement, a top temperature reading, a bottom temperature reading, an average temperature determination, a gravity, a free water amount, or a base sediment and water determination of a storage of crude oil comprising the net volume of crude oil to be purchased.

18. A method according to claim 11, wherein at least one of the one or more producer client applications and/or at least one of the one or more purchaser client applications are embodied in one or more mechanical sensors associated with a tank having the crude oil to be purchased.

19. A method according to claim 11, further comprising one or more mechanical sensors associated with a tank having the crude oil to be purchased, wherein the one or more sensors are configured to communicate with one or more corresponding devices executing the one or more producer client applications and/or with one or more corresponding devices executing the one or more purchaser client applications, the sensors communicating one or more data points of the measurement data related to the purchase for the net volume of crude oil.

20. A method according to claim 11, wherein the computer network is the Internet.
